(19) United States
(12) Patent Application Publication
(10) Pub. No.: US 2005/0015291 A1
(43) Pub. Date: Jan. 20, 2005

(54) Employee development management method and system

(76) Inventor: Joseph J. O'Connor, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/891,862

(22) Filed: Jul. 15, 2004

Related U.S. Application Data
(60) Provisional application No. 60/487,633, filed on Jul. 16, 2003.

(51) Int. Cl. G06F 17/60

(52) U.S. Cl. 705/8

(57) ABSTRACT

A computer based system and method manages and tracks development of employees for an educational organization. Development and government requirements data relating to the development of the employees is stored in a database. The system and method provide access to the data to the employees and allow an employee to manage an employee development plan as a function of the data and achievement data related to the progress of the students. The system and method also establish feedback data related to effectiveness of the employee development plan and modifies the employee development plan as a function of the effectiveness of the employee development plan.

This application claims the benefit of U.S. Provisional Application No. 60/487,633, filed Jul. 16, 2003.

### FIELD OF THE INVENTION

The present invention relates generally to the development of employees, and more particularly, to a system and method for managing the development of the employees of organizations.

### BACKGROUND OF THE INVENTION

Organizations and their employees, such as businesses and educational organizations, as industries are becoming subjected to increasing regulations. For example, professionals, such as medical professionals and teachers, are often regulated by federal, state and local laws. Other employees may also be regulated regarding their training on such subjects as sexual harassment and hazardous materials.

Often times it is the responsibility of the organization to provide such training, but left to the individual to be aware of the requirements, sign up for courses or other training that meets the requirements, and generally, to track their own progress on meeting the requirements. The requirements for a particular individual based on their jib category, their progress, and plan for meeting these requirements are generally known as a development plan.

Historically, an individual must rely on the organization to provide the requirements and their progress on meeting these requirements are generally accomplished using paper files. This is not an efficient process. Nor is the process sufficient to ensure that all employees are aware of their requirements or are aware of the courses available to meet their requirements. Furthermore, it is difficult for the organization to ensure that it is complying with the regulations.

The present invention is aimed at one or more of the problems identified above.

### SUMMARY OF THE INVENTION

In one aspect of the present invention, a computer based system development of employees for an educational organization is provided. Development and government requirements data relating to the development of the employees is stored in a database. The system provides access to the data to the employees and allows an employee to manage an employee development plan as a function of the data and achievement data related to the progress of the students. The system also establishes feedback data related to effectiveness of the employee development plan and modifies the employee development plan as a function of the effectiveness of the employee development plan.

In another aspect of the present invention, a computer based method for managing and tracking development of employees of an organization, is provided. The method includes the steps of storing employee development and government requirements data relating to the development of the employees in a database and providing access to the data to the employees. The method further includes the steps of providing access to the data to the employees and allowing an employee to manage an employee development plan as a function of the data and achievement data related to the progress of the students. The method establishes feedback data related to effectiveness of the employee development plan and modifies the employee development plan as a function of the effectiveness of the employee development plan.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of a system for managing and tracking development of employees for an organization, according to an embodiment of the present invention;

FIG. 2 is a flow diagram of a method for managing and tracking development of employees for an organization, according to an embodiment of the present invention;

FIG. 3 is a diagrammatic illustration of a Logon screen, according to an embodiment of the present invention;

FIG. 4 is a diagrammatic illustration of a News Bulletin Board screen, according to an embodiment of the present invention;

FIG. 5 is a diagrammatic illustration of a Development Plan screen, according to an embodiment of the present invention;

FIG. 6 is a diagrammatic illustration of a Change Validation popup, according to an embodiment of the present invention;

FIG. 7 is a diagrammatic illustration of a Check Requirements panel, according to an embodiment of the present invention;

FIG. 8 is a diagrammatic illustration of a Available Courses panel, according to an embodiment of the present invention;

FIG. 9 is a diagrammatic illustration of an Available Courses drop down list, according to an embodiment of the present invention;

FIG. 10 is a second diagrammatic illustration of the Available Courses panel, according to an embodiment of the present invention;

FIG. 11 is a third diagrammatic illustration of the Available Courses panel, according to an embodiment of the present invention;

FIG. 12 is a diagrammatic illustration of an Available Courses—Calendar panel, according to an embodiment of the present invention;

FIG. 13 is a diagrammatic illustration of a Special Request panel, according to an embodiment of the present invention;

FIG. 14 is a diagrammatic illustration of a Reports panel, according to an embodiment of the present invention;

FIG. 15 is a diagrammatic illustration of an Administrative View screen, according to an embodiment of the present invention;

FIG. 16 is a diagrammatic illustration of a View/Edit panel, according to an embodiment of the present invention;

FIG. 17 is a diagrammatic illustration of a Course Requirements popup, according to an embodiment of the present invention;

FIG. 18 is a diagrammatic illustration of a proactive email communication, according to an embodiment of the present invention;

FIG. 19 is a flow diagram of a computer based method for managing and tracking development of employees of an organization, according to an embodiment of the present invention;

FIG. 20 is a diagrammatic illustration of a post-session survey, according to an embodiment of the present invention; and,

FIG. 21 is a diagrammatic illustration of a post-session survey (30 days), according to an embodiment of the present invention.

### DETAILED DESCRIPTION OF THE PREFERRED EMBODIMENT

With reference to the drawings and in operation, the present invention provides a computer based system for computer based system 10 for managing and tracking development of employees of an organization. One suitable organization is an education organization, such as a public school, a school district containing a plurality of schools, a state having a plurality of districts, or a multi-state organization each having one or more districts.

Each school has a plurality of employees. The employees of the school may be categorized according to their job functions, e.g., teachers, administrators (such as principals or human resource managers), and other staff employees, such as bus drivers, cafeteria workers, health workers etc. Each category may have different requirements. For example, teachers may have government requirements as new teachers and may have continuing education requirements to maintain licensure as a teacher. Other employees may have requirements related to providing medical assistance (such as CPR) or dealing with hazardous materials. As described below, the system 10 allows individual employees to view their requirements (based on their job classification), view their progress on meeting these requirements, and update and plan their Development Plan.

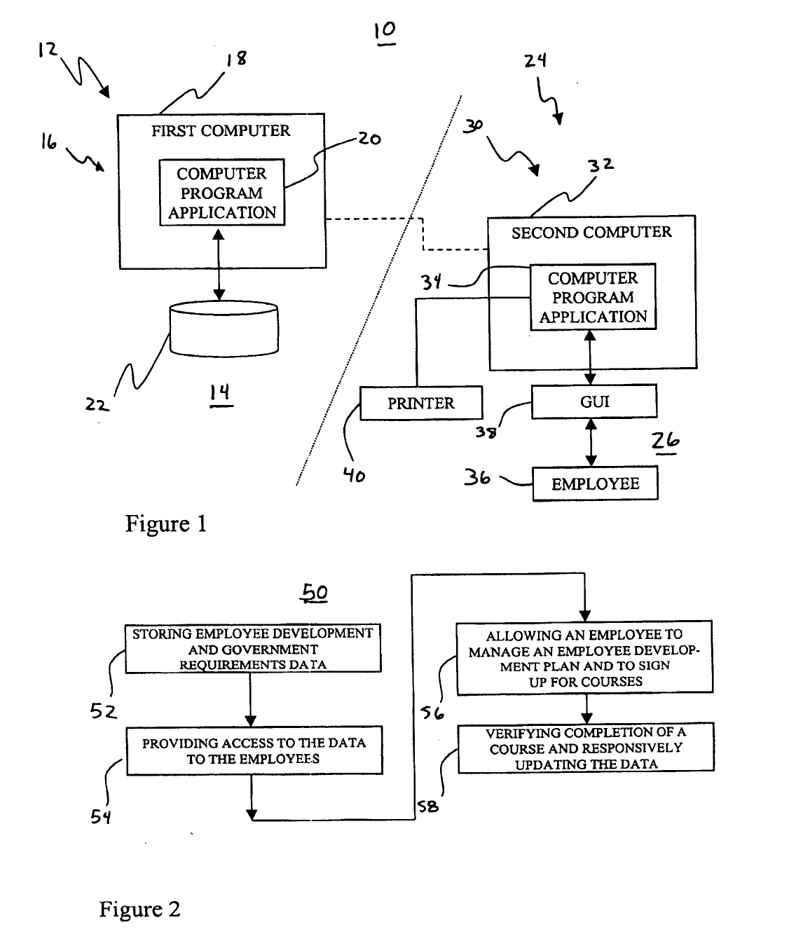

With reference to FIG. 1, the system includes a first computer system 12 located at a central location 14. The first computer system 12 includes a first processing unit 16 which is implemented in at least one first computer 18 and one or more computer program applications 20 running on the at least one first computer 18. A database 22, coupled, to the first computer system 12, stores employee development data (including individual development plans) and the government requirements data (including the requirements for each job classification or category). In one embodiment, the database 22 is a relational database and the computer program applications 20 include a database program.

In one embodiment, the system 10 may be accessed by users through the first computer system 12. Users may include employees accessing and updating their development plan, administrators updating information stored on the database 22 (such as available classes), and system managers managing the system 10 and/or database 22.

In another embodiment, the system 10 includes a second computer system 24 located at a remote location 26. The first and second computer system 12, 24 are coupled via a computer network 28, such as the internet. The second computer system 22 includes a second processing unit 30 which includes at least one second computer 32 and one or more computer program applications 34. The second computer system 24 provides access to the system 10 to employees 36 through a graphical user interface (GUI) 38. In one embodiment, the GUI 38 is implemented as a web page. The one or more computer program applications 34 includes a web browser, such as, Internet Explorer available from Microsoft Corporation of Redmond, Wash. for displaying the GUI 38.

In one embodiment, the second computer system 24 may include a printer 40 which reports to be printed. Alternatively, the printer 40 may be separate from the system 10 or connected to another computer on the network 28.

In a first embodiment of the present invention, the system 10 is a stand-alone system allowing employees to access and manipulate their own development plan. The first processing unit 12 provides access to the data to the employees, allows an individual employee to manage an employee development plan as a function of the data and to sign up for courses to meet the government requirements. The processing unit 12 verifies the completion of a course by the employee and for responsively updating the employee development data. A course may include a traditional type of course with instructor and student(s) in a class room, a web-based course, or any other type of instruction or event which meets the requirements, e.g., a mentoring session with a more experienced employee.

In a second embodiment of the present invention, the at least one first computer 18 is a file server which interacts with the at least one second computer 32. The first processing unit 12 accesses and manipulates the data stored in the database 22. The second processing unit 24, provides access to the system 10 to one or more users or employees 36.

In one embodiment of the present invention, the first processing unit 12 is adapted o provide news related to the organization or development plan to the employee. This may be done, for example, using a bulleting board news section (see below), which provides general interest news items to employees, such as meeting notices.

With reference to FIG. 2, in another aspect of the present invention, a method 50 for managing and tracking development of the development of employees of an organization, according to an embodiment of the present invention, is illustrated.

In a first process step 52, the method includes the step of storing employee development and government requirements data. In a second process step 54, access to the data is provided to the employees. An employee of the organization is allowed to manage an employee development plan and to sign up for courses to meet the requirements. In a fourth process step 54, completion of a course is verified and the data stored is updated.

In another aspect of the present invention, the system 10 and method 50 are adapted to send email communications to users. In one embodiment, the email communications are pro-active and timely with regard to a user's development plan. The email communications may be time sensitive and relative to specific issues. The communications may automatically alert individual users with respect to their individual status, at any given time, in relation to their individual requirements as set forth by supervisor, local district, or a governing regulatory agency. For example, an email communication may include a confirmation of registration, cancellation or completion of course or requirement. In another example, an email communication may be sent at predetermined times (of the year or relative some other event) as a reminder to users to update their development plans. Additional email communication may be related, but are not limited to, course notifications, requests to update professional development plan, status of special requests, and special requests in queue.

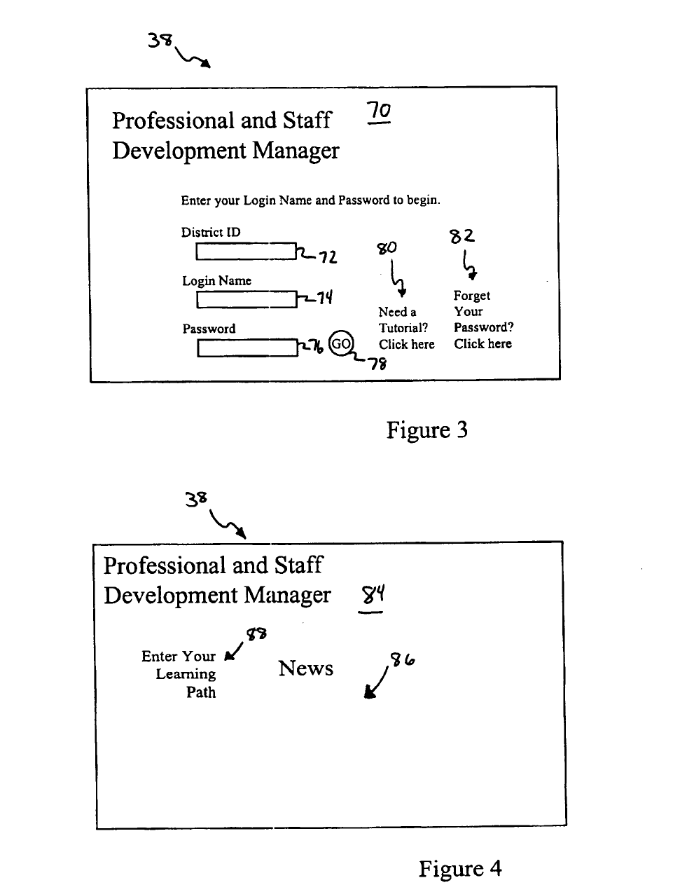

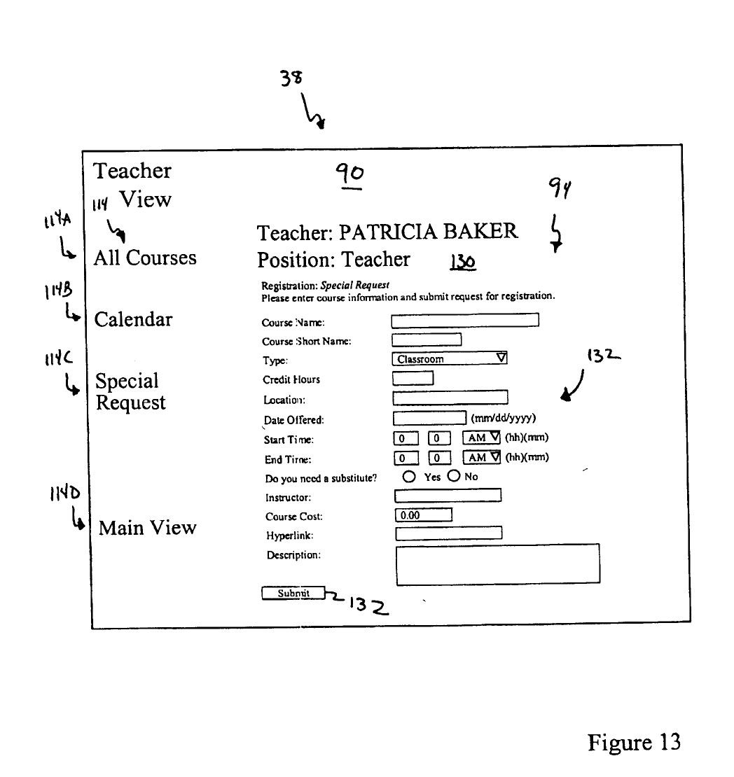

With reference to FIGS. 3-18, in one embodiment the system 10 is adapted to provide access to and manage the individual development plans of at least one employee of an education organization, e.g., a school, school district, state, or multi-state region. The at least one employee may be a teacher, administrator (such as a principal or human resource manager), or a staff employee, such as a bus driver, a cafeteria worker, health worker, and/or other employee, etc. Each type or category of employee may have different requirements, and this, their development plan may be tailored to meet such requirements. In one aspect of the present invention, the first computer system 12 includes one or more first computers 18, which act as servers for the second computer system 24, and are located at the central location 14.

The system 10 is accessed by one or more second computers 32 which may be located at one or more locations remote 26 from the central location 14. In one embodiment the second computers 32 are coupled to the first computer system 12 via the internet. The system 10 is accessed by employees 36 of the organization via a web-based GUI 38. The web-based GUI 38 may be accessible through any computer connected to the internet, including, but not limited to, schools located at a facility owned or operated by the organization, computers located at public locations, and/or home computers.

With reference to FIGS. 3-17, sample screen shots from one embodiment of the GUI 38 are illustrated and will be used to describe operation of the system. It should be noted that the system 10 may be implemented in a manner different from that illustrated in the sample screen shots. FIGS. 3-14 illustrate sample screen shots for an employee who is a teacher.

With specific reference to FIG. 3, the GUI 38 is accessed through a uniform resource locator address or URL which is entered into a web browser. Access of the URL displays a Logon Screen 70. The Logon Screen 70 includes a District ID text box 72, a Login Name text box 74, a Password text box 76, and a GO button 78. from an embodiment of the present invention. The system 10 in the illustrated embodiment is adapted for use with a multi-district organization. Thus to enter the system, the employee 36 enters a district identification, an (assigned) Login Name, and their Password in the appropriate text box 72, 74, 76 and actuates the GO button 78.

In addition, the Logon Screen 70 includes a Need a Tutorial link 80 and a Forget Your Password link 82. The Need a Tutorial link 80 navigates to a tutorial (not shown). The Forget Your Password link 82 navigates to a screen which allows the employee to have their password emailed to the email address.

Once the employee 36 has successfully entered their login ID and password, a News Bulletin Board screen 84 is displayed (see FIG. 4). The News Bulletin Board screen 84 includes a news section 86 where news items, recent events or notices may be posted. For example, reminders regarding holidays, meetings, new course offerings or cancellations, or new requirements, etc., may be posted. Typically only certain employees 36, such as administrators, have authority to post news items.

The News Bulletin Board screen 84 also includes an Enter Your Learning Path link 88.

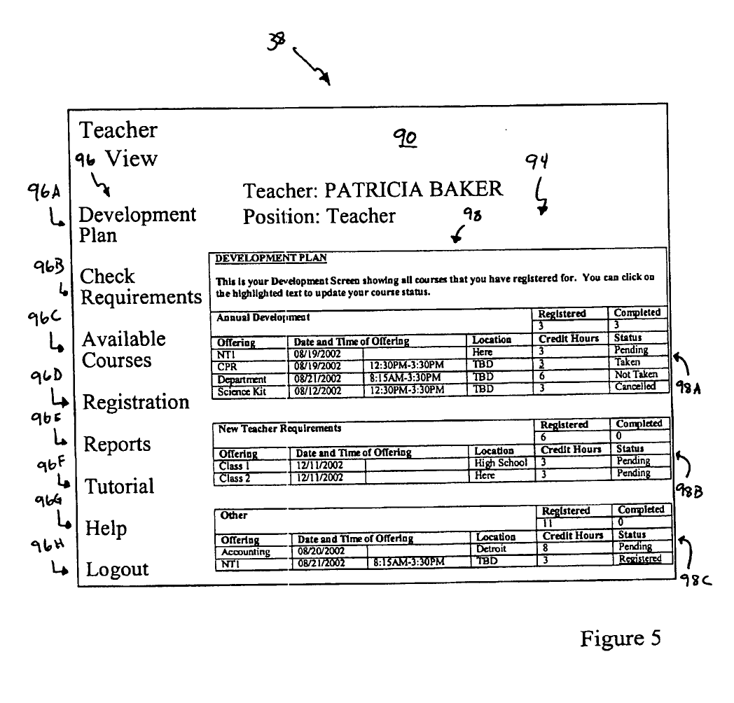

With reference to FIG. 5, selection of the Enter Your Learning Path link 88 navigates to a Development Plan screen 90. The Development Plan screen 90, allows the employee to view and manage their own development plan. The Development Plan screen 90 includes an Employee Identification area 92 which identifies the employee by name and category, e.g., teacher. The Development Plan screen 90 also includes a work area 94 and a list of links 96. The work area 94 displays information related to the employee's development plan. The list of links 96 includes a number of links which assist the employee 36 in navigating the system 10 and managing their development plan. In the illustrated embodiment, the list of links 96 includes a Development Plan link 96A, a Check Requirements link 96B, an Available Courses link 96C, a Registration link 96D, a Reports link 96E, a Tutorial link 96F, a Help link 96G, and a Logout link 96H.

Operation of the Development Plan link 96A, the Check Requirements link 96B, the Available Courses link 96C, the Registration link 96D, and the Reports link 96E will be discussed in detail below. Selection of the Tutorial link 96F navigates to a tutorial for the system 10. Selection of the Help link 96G, navigates to one or more Help screens (not shown) for the system 10. Selection of the Logout link 96H logs the employee 36 out of the system 10.

When the employee 36 first select the Enter Your Learning Path link 88 or selects the Development Plan link 96A, a development screen panel 98 is displayed in the word area 94. The development screen panel 98 includes a list of the courses which the employee 36 has taken or registered to meet their governmental requirements. The first time the employee 36 logs into the system 10, their development plan may be empty or may include some courses for which they have been pre-registered. The plan may also include any carry over credit hours from previous years, if applicable.

In the illustrated embodiment, the employee's development plan has three category of requirements: Annual Development, New Teacher Requirements, and Other. Annual Development requirements refer to requirements which all employees of the same category must meet, e.g., continuing educational requirements. New Teacher requirements are requirements which only new teachers must meet. Other Requirements may include requirement set up by the organization or regulatory authority and may be required for all employees, a subset of employees, or just the current employee. The development screen panel 98 includes an Annual Development section 98A, a New Teachers Requirements section 98B, and an Other section 98C. Each section 98A, 98B, 98C provides details regarding the courses taken or registered by the employee 36 in each category (including name or offering, the date and time, and location, credit hours, and status), as well as the number of credits registered in each category and the number of credits completed in each category.

In one embodiment, each course may have a status of pending, denied, taken, not taken, cancelled, or registered. A course that is pending refers to a special course that the employee 36 has requested (see below). A status of denied refers to a special course request that has been denied. A cancelled course is a course for which the employee had previously registered, but that has since been cancelled.

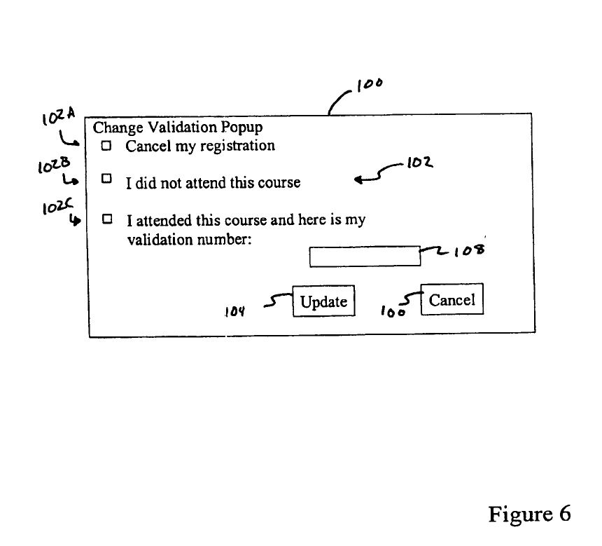

A portion of the listing for each course, e.g., the status, may be linked to allow the employee 36 to update. For example with reference to FIG. 6, selection of the a linked status displays a Change Validation popup 100. The Change Validation popup 100 includes a plurality of options 102 which may include a Cancel my registration option 102A, a I did not attend this course option 102B, and a I attended this course option 102C. The Change Validation popup 100 also includes an update button 104 and a cancel button 106. To update the status of a course on their development plan, the employee 36 checks the appropriate box corresponding to the option and actuates the update button 104. Additionally, the course title may be linked if the course is web-based or may provide a link to allow the employee 36 to change the requirement to which the course is being applied.

Attendance or completion of a course may be accomplished using a plurality of methods. For example, the employee 36 may be allowed to indicate attendance by indicating using the Change Validation popup 100. Alternatively, the Change Validation popup 100 may require that the employee 36 input a validation number into a validation number text entry box 108, which was given to the employee 36 by the instructor of the course. Alternatively, completion or attendance may be validated by the instructor or some other means.

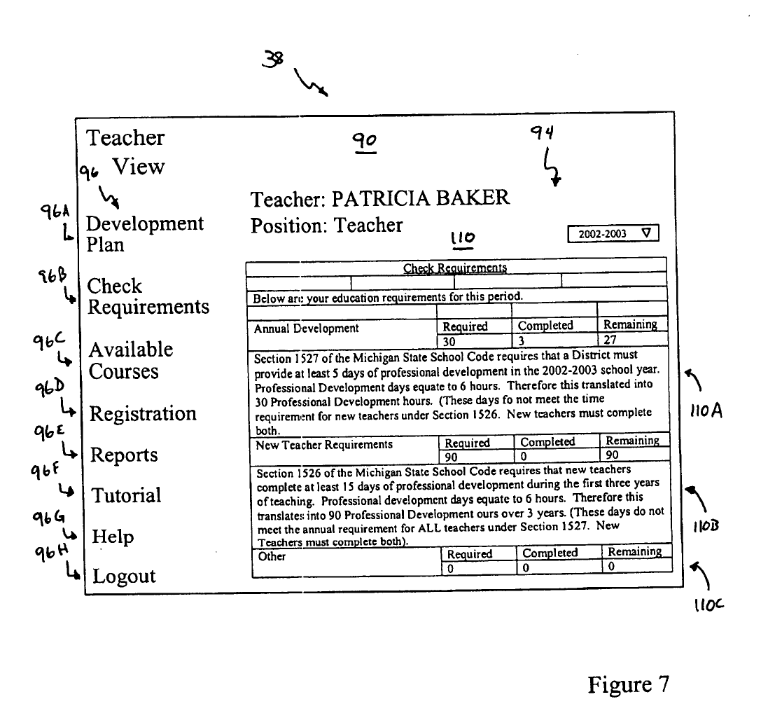

With reference to FIG. 7, selection of the Check Requirements link 96B, displays a Check Requirements panel 110 in the work area 94. The Check Requirements panel 110 displays information relating to the employee's 36B status in each category of requirements. In the illustrated embodiment, the employee's requirements are categorized as Annual Development requirements, New Teacher requirements, and Other requirements. Details for each category are displayed in an Annual Development section 110A, a New Teacher requirements section 110B, and an Other requirements section 110C, respectively. Each category is detailed with the number of credit hours required, the number of credit hours completed, and the number of credit hours remaining (that must be completed by the employee 36). Additionally, other descriptive text may be supplied, as shown.

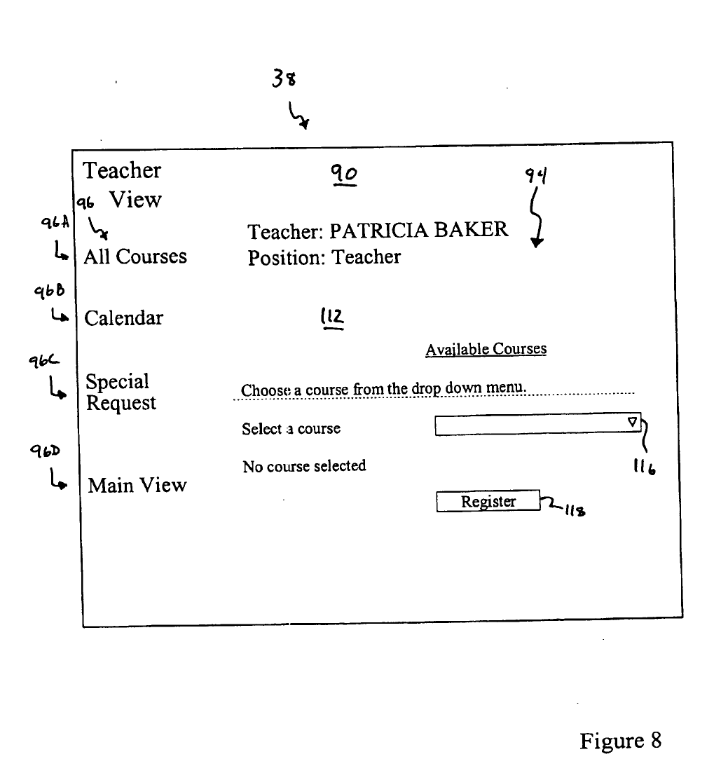

With reference to FIG. 8, selection of the Available Courses link 96C displays an Available Courses panel 112 in the work area 94. Additionally, a list of course links 114 are displayed. In the illustrated embodiment, the list of course links 114 include an All Courses link 114A, a Calendar link 114B, a Special Request link 114C, and a Main View link 114D. Actuation of the Main View link 114D, navigates back to the development plan view (see above).

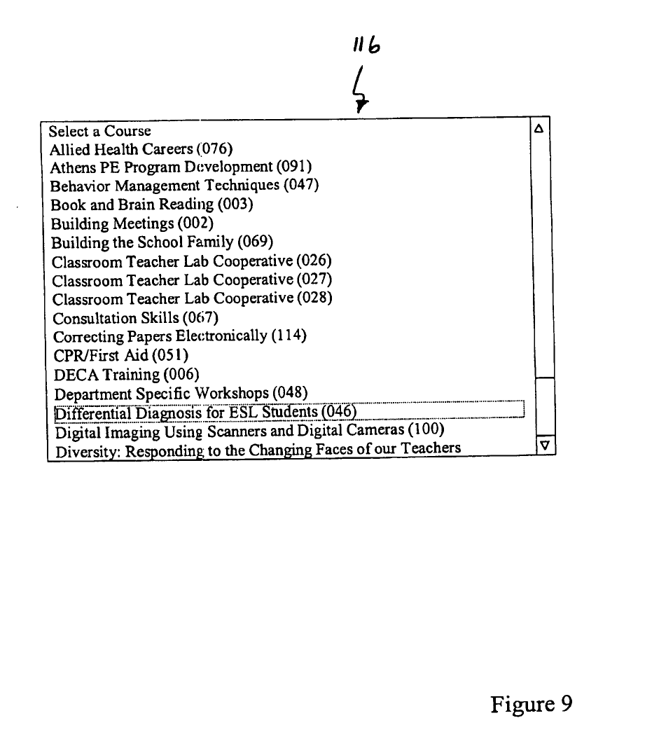

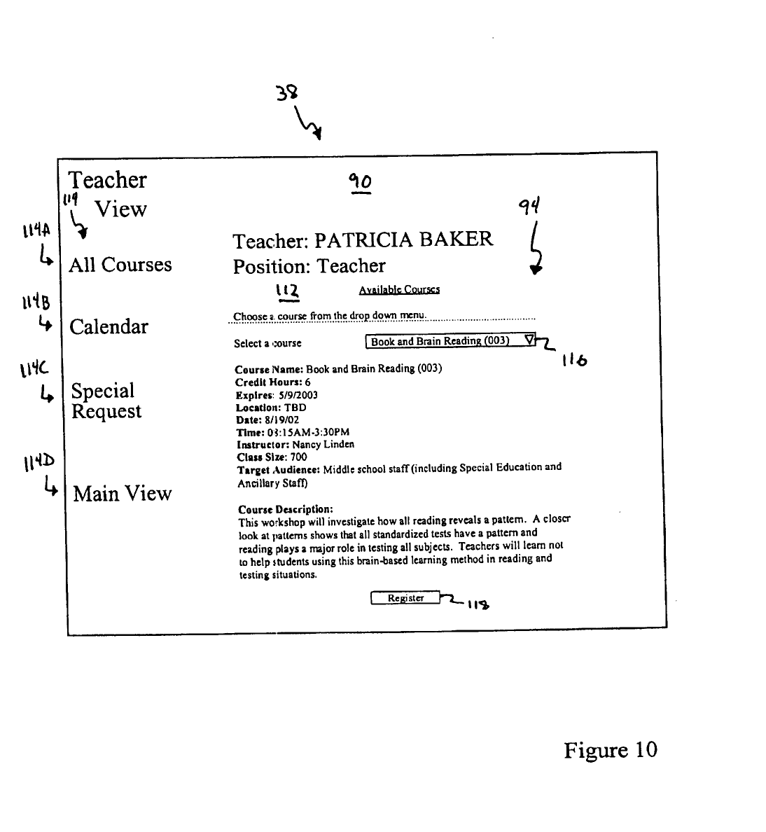

When the Available Courses link 96C or the All Courses link 114A the Available Courses panel 112 is displayed. The Available Courses panel 112 includes an Available Courses drop down list 116 and a Register button 118. With reference to FIG. 9, expansion of the Available Courses drop down list 116 allows the employee 36 to select an available course from a scrollable list. With reference to FIG. 10, selection of an available course in the Available Courses drop down list 116, displays information related to the selected course, including for example, name, credit hours, location, date, time, instructor, class size, target audience, and a course description. Actuation of the Register button 118 registers the employee 36 for the course. When the employee 36 is registered for a course, their data in the database 22 and their employee development plan is updated. Navigation back to the Development Plan screen 90 will display the updated plan.

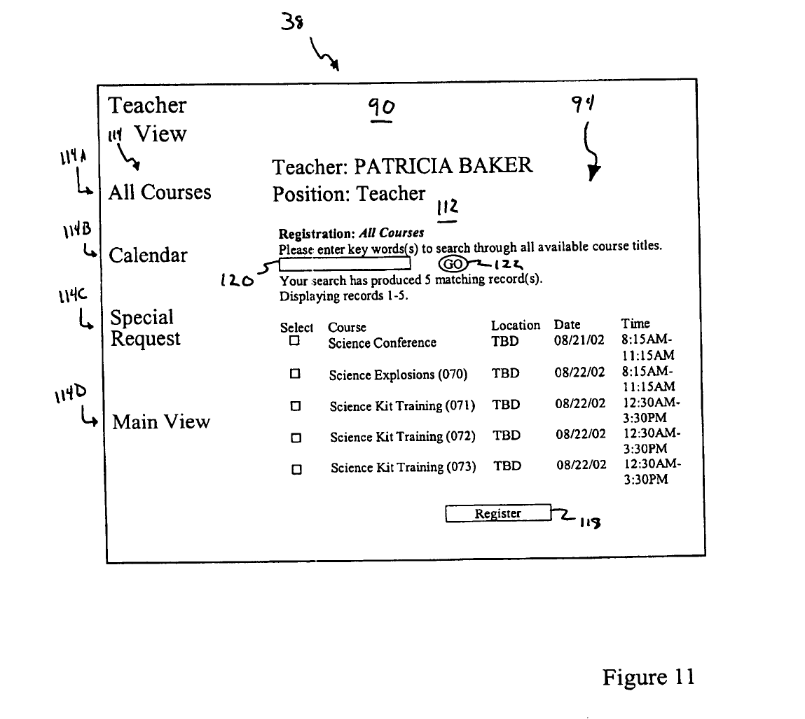

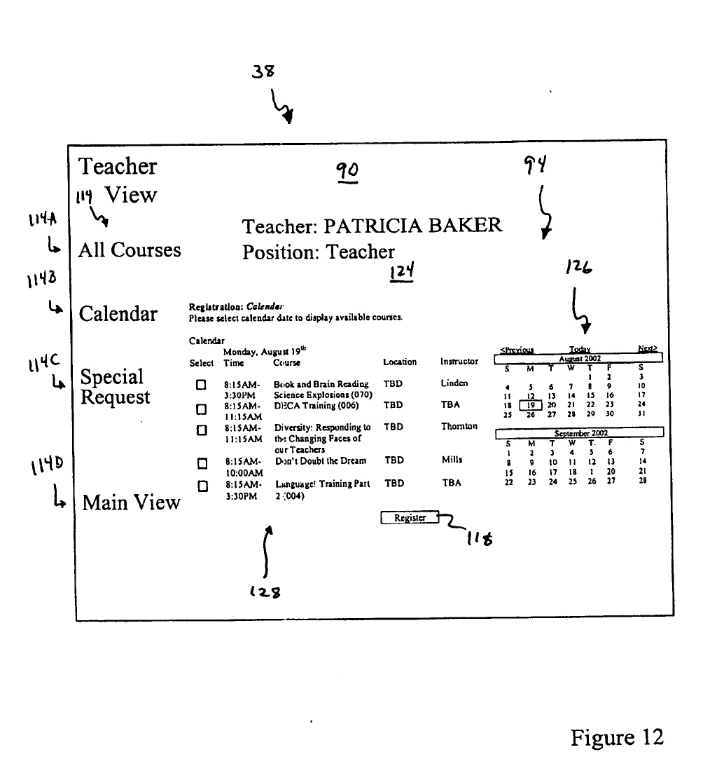

With reference to FIGS. 11 and 12, the employee 36 may search and register for courses using additional methods. With reference to FIG. 11, the employee 36 may search for available courses by entering a key word or words in a search box 120 and actuation a GO button 122. Courses containing the entered key word(s) are displayed in the Available Courses panel 112. The employee 36 may select one or more of the listed courses and register by actuating the Register button 118.

Selection of the Calendar link 114B, displays an Available Courses—Calendar panel 124. The Available Courses—Calendar panel 124 includes a calendar 126 which is the employee 36 may scroll forward and back. Selection of a day on the calendar 126, displays a list 128 of the courses available on the selected day. The employee 36 may select one or more of the listed courses and register by actuating the Register button 118.

Selection of the Special Request link 114C, displays a Special Request panel 130 which allows the employee 36 to request a course that is not currently listed as available. For example, the employee 36 may request a course that is being offered at a local college. The Special Request panel 130 includes a form 132 in which the employee 36 provides detail about the requested course.

Once the form 132 is filled out, the employee 36 actuates a Submit button 132 to submit the request. In one aspect of the present invention, the request is transferred to another employee, such as an administrator or a principal or other designated employee, who reviews the request and approves or denies the request.

In one embodiment, the employee who reviews the request receives an email with the request.

In another embodiment, the request may be displayed to the designated employee when they log onto the system 10. Additionally, an email may be sent to the designated employee when they have a request (or a certain number of requests) which must reviewed.

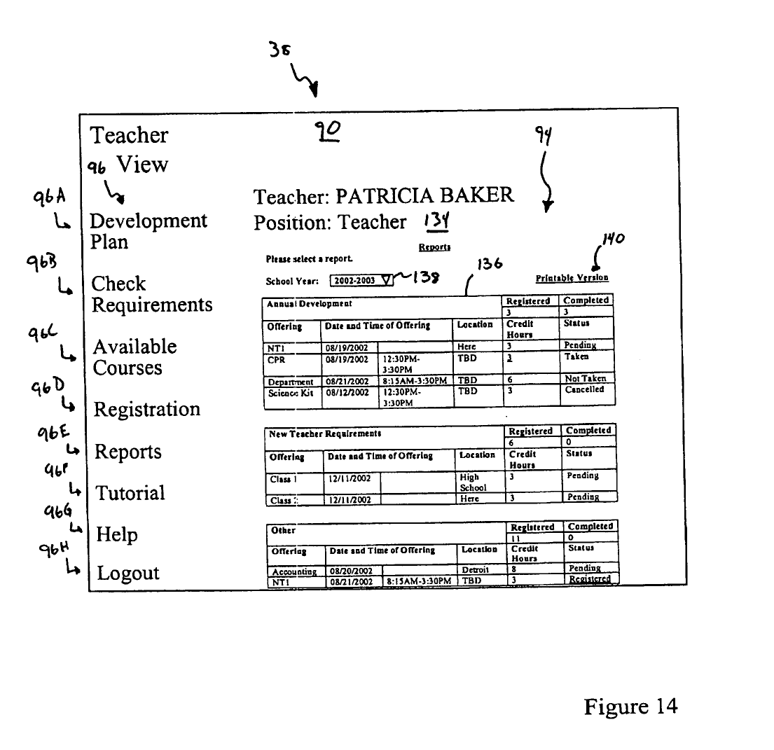

With reference to FIG. 14, selection of the Reports link 96E displays a Reports panel 134. The Reports panel 134 displays a report 136 which includes details regarding the employee's development plan. The Reports panel 134 also includes a School Year drop down list 138 which allows the employee 36 to choose the school year for which a report is generated. Selection of a Printable Version link 140, displays a version of the report which is formatted for printing.

As discussed above, the features of the system 10 available to the employee 36 may vary depending on their category of employee. For example, a teacher may be able to view their requirements and their development plan. An administrator may be able to view their requirements and their development plan. Additionally, the administrator may have access to other portions of the system 10 as a result of their responsibilities, e.g., reviewing special course requests (see above), review the development plan of other employees and/or adding, modifying or removing courses from the list of available courses.

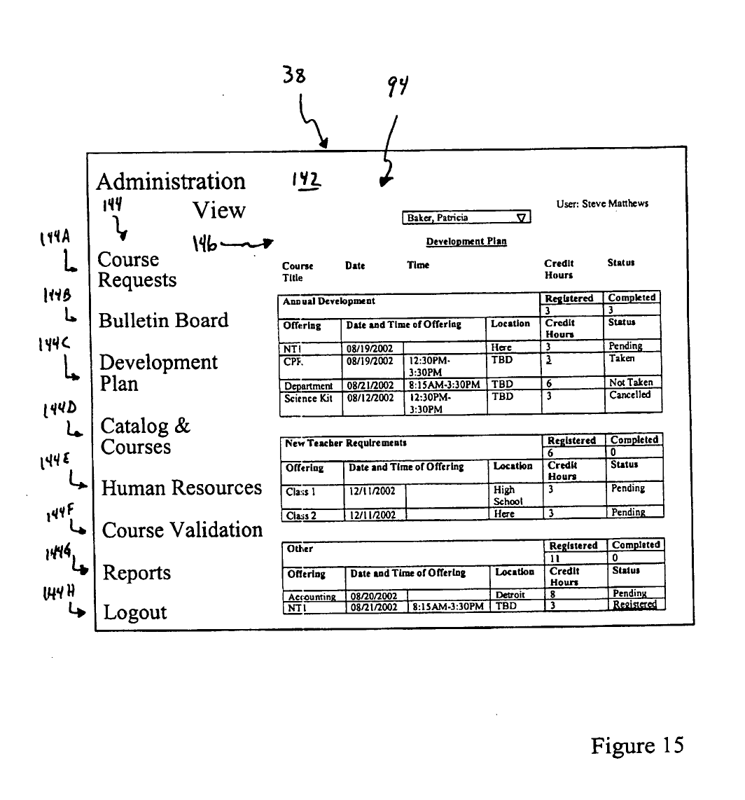

With reference to FIG. 15, if an administrator 36 logins into the system 10, an Administration View screen 142 may be displayed in the GUI 38. The Administrative View screen 142 includes a list of administration links 144. In the illustrated embodiment, the list of administration links 144 includes a Course Requests link 144A, a Bulletin Board link 144B, a Development Plan link 144C, a Catalog and Courses link 144D, a Human Resources link 144E, a Course Validation link 144F, a Reports link 144G, and a Logout link 144H.

Selection of the Course Requests link 144A navigates to a screen (not shown) which allows the administrator to review and approve or deny received course special requests (see above).

Selection of the Bulletin Board link 114B navigates to a screen (not shown) which allows the administrator to add, modify, or delete items on the bulleting board.

Selection of the Human Resources link 114E navigates to a screen (not shown) which allows the administrator access to human resources related functions.

Selection of the Reports link 114G navigates to a screen (not shown) which allows the administrator to prepare and print out reports of the development plans of the employees.

Selection of the Logout link 114H logs the administrator out of the system 10.

Selection of the Development Plan link 144C, displays an Administrator Development Plan panel 146 in the work area 94. The Administrator Development Plan panel 146 includes an Employee drop down list 148 and a Plan section 150. The Employee drop down list 148 includes all of the employees for which the administrator has access (which may be all or less than the employees in the organization). The administrator selects an employee in the Employee drop down list 148 and that employee's development plan is displayed in the Administrator Development Plan panel 146.

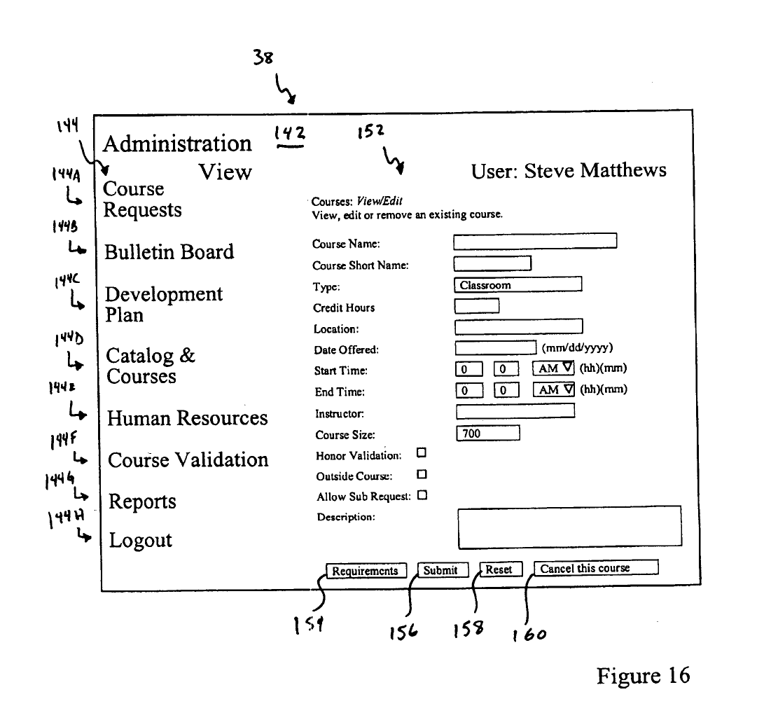

Selection of the Catalog & Courses link 144D allows the administrator to review, modify, cancel or add courses to the list of available courses. With specific reference to FIG. 16, a View/Edit panel 152 allows the administrator to review and modify the existing information for a course and add a new course. The View/Edit panel 152 includes a Requirements button 154, a Submit button 156, a Reset button 158, and a Cancel this course button 160.

Selection of the Submit button 156 updates the database 22 with the modified course data or the new course. Selection of the Reset button 158 clears the data in the View/Edit panel 152. Selection of the Cancel this course button 160 removes the course from the list of available courses.

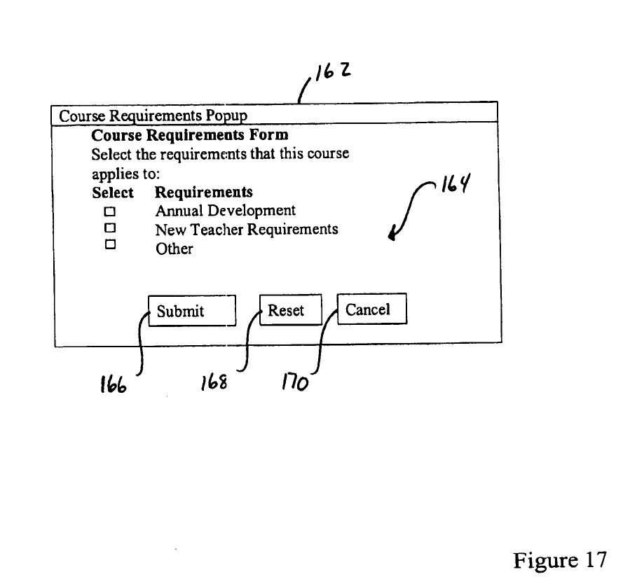

With reference to FIG. 17, selection of the Requirements button 154 displays a Course Requirements popup 162. The Course Requirements popup 162 allows the administrator to select the requirements to which the course applies. For example, the course may be used to meet the annual development requirements, the new teacher development requirements, the other requirements, or any combination thereof.

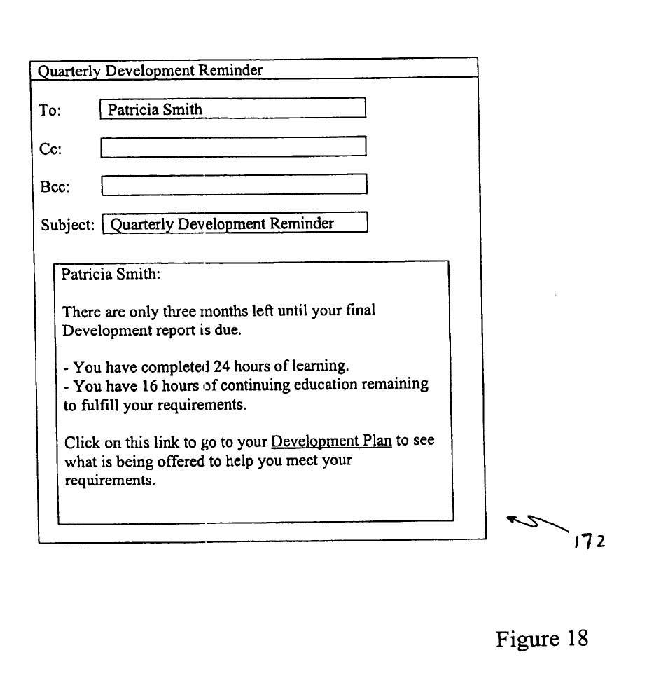

As discussed above, email communications may be used to automatically alert users in a timely manner about specific events. For example, in FIG. 18, a sample email communication 172 is shown. The sample email communication 172 provides a reminder to the targeted user, Patricia Smith, that she has only three month until her final development report is due. The email communication 172 may also give additional, related information, such as the number of completed hours and the number of remaining hours. Also, the email communication 172 may provide a link, as shown, to the user's development plan.

The above description of the sample screen shots illustrate a system which has been adapted for use with an educational organization and has been described with respect to teachers and an administrator. However, it should be recognized that variations of the screen shots are possible without departing from the invention. Furthermore, the GUI may be dynamic in that the contents of each screen may vary as a function of the individual employee, the category of the employee, the particular government and organization requirements, and/or the size and structure of the organization.

Virtually anyone connected with K12 education in America knows that the quality of schools is synonymous with the quality of the teachers and other leaders in those schools. There has been a vast amount of scientific research conducted over the last ten years that points to teacher quality as the single most important factor influencing student achievement. Furthermore, reform of the Elementary and Secondary Educational Act (“No Child Left Behind”) placed enormous emphasis on teacher quality, making it a national priority. Independent of the new federal requirements, progressive school administrators and teachers are placing additional focus on examining practices that will enhance teacher quality. At the same time, parents are recognizing that like any other organization, quality outcomes in a school environment are dependent in large part on the quality and capability of the people responsible for those outcomes.

Professional development for teachers, administrators and other school personnel is a critical component in enhancing classroom skills. However, too often there is a disconnect between professional development activity and the relevant needs of students in the classroom. The National Staff Development Council has developed nationally recognized standards for staff development. The standards are organized around three core elements: Context, Content and Process. The process element is intended to address the use of “data, evaluation and research”. This element is often lacking in many environments and yet vital in terms of measuring the ultimate impact of both content and context on student learning. As a result, teachers and administrators lack the tools to make informed, data driven decisions that will lead to enhancements in professional development that are relevant to student learning.

In another aspect of the present invention, the system provides a research based management information system to enhance professional development, teacher skills and student achievement.

In one aspect, the purpose of this system 10 is to implement a process for professional development among a consortium of school districts in that will use a research based management information system. The system 10 will seek to tie all professional development activities to identified student needs. The process will be designed to encourage experimentation with a variety of Professional Development offerings. The presumption is that not every professional development offering is necessarily effective and therefore, the process is designed to test, evaluate, modify, evaluate, etc. The underlying premise is that excellence is a journey and not a destination. More specifically, improvement should be continuous and can only be sustained with ongoing, data driven evaluation.

The primary objectives of the project are as follows:

1. To establish individual professional development goals for each participating teacher, which are aligned with district, building and classroom goals. These goals will be drawn from a compilation of a variety of student data;

2. To enable teachers to build and manage their own portfolio, while also allowing principals to track progress of their direct reports;

3. To allow dynamic, practical collaboration between teachers, mentors and other facilitators on effective classroom practice;

4. To minimize the administrative burden associated with tracking and managing professional development;

5. To implement a dynamic research process that will evaluate Professional Development offerings from both a content and context perspective, measuring specific Professional Development experiences in terms of the impact on student learning;

Research Process:

1. Teachers will complete a survey at the point of Professional Development registration, which will seek to uncover their motivation in choosing a particular workshop/class, how it relates to their individual plan and what there expectations are with respect to impact in the classroom;

2. Upon completing the workshop/class teacher will be given a follow up survey to report on strengths and weaknesses of offering from both content and context perspective; “Do you believe the course met your objectives based on your Individual Development Plan, classroom needs?” “Did it meet your expectations?” etc.

3. Ongoing follow up quantitative surveys, 30, 60, 90 days, etc. after actual classroom experience to assess practical effectiveness in light of goals and student needs;

4. Conduct periodic qualitative focus groups with teachers and principals to discuss issues relevant PD impact on student learning;

5. Surveys administered periodically to mentors, 3rd party teams/observers to validate/compliment self reported teacher data;

6. Correlate and compare teachers' professional development data with student achievement data by individual teacher, building, classroom;

7. Train school leadership to use data to guide decisions relative teacher skills and future Professional Development offerings;

8. System becomes an ongoing, continuous process for improvement.

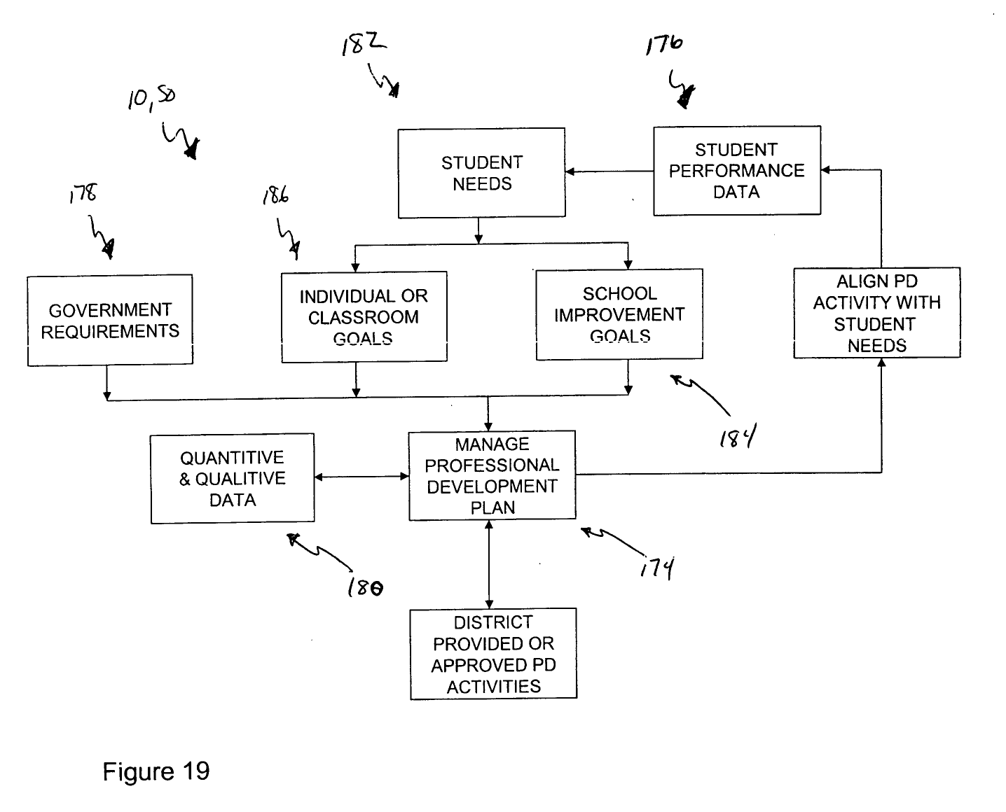

With reference to the Figures and specifically, FIG. 19, in one embodiment of the present invention, the system 10 and method 50 allow the employees 36 of an educational organization, such as a school system, to manage an employee development plan 174 as a function of the development and requirements data 178 and achievement (or student performance) data 176 related to the progress of the students. The achievement data may be government data related to results from standardized testing. The achievement data may be stored in the database 22 or another database. The system 10 and method 50 also establish feedback data 180 related to effectiveness of the employee development plan and may modify the employee development plan 174 as a function of the effectiveness of the employee development plan (see below).

For example, in one embodiment feedback 180 data is supplied through one or more surveys which are filled out by the employees 36 (see below).

In one embodiment, the first processing unit 16 provides the ability to modify the requirements data as a function of the effectiveness of the employee development plan. In one aspect of the present invention, the effectiveness of employee development plan may be measured by changes in the achievement data 176 and correlating the changes to the employee development plans. As discussed above, the employee development plan may include one or more courses related to the employee's development, which may be selected by an employee 36. Based on the effectiveness of the employee development plan, course requirements may be added, deleted or substituted or course content may be changed based on the effectiveness.

In one embodiment of the present invention, when an employee 36 logs into the system 10, the first processing unit 16 may recommend courses for the employee development plan, which may be based on one or more of the following: the employee development data, the requirements data, and the achievement data.

In another aspect of the present invention, the first processing unit 16 establishes quantitative data 180 related to the effectiveness of the employee professional development plan (see below). In one embodiment, the quantitative data 180 is established through evaluative research gathered through one or more online surveys.

For example, the first processing unit 16 may allow the employee to register for a course through a registration process (see above) and may require the employee to fill out an online survey prior to registration. The pre-registration survey may be aimed at objectives related to the employee's motivation for choosing the course for which the employee is registering. Additionally, the first processing unit 16 may also require the employee to fill out an online survey prior after the course has occurred. The post-course online survey may be aimed at objectives related to how well the course met the employee's expectations and applicability of the course to practice. Additional online surveys may be aimed at determining the applicability and impact of the course on practice at key points, for example, 30, 60, and/or 90 days, after completion of the course.

In one embodiment, the quantitative data may be utilized to modify the employee development plan. For example, the quantitative data may be used to modify course recommendations and/or course content.

Quantitative Research

One of the goals of the system 10 method 50 is to implement a dynamic research process that will evaluate professional development offerings from a content and context perspective, measuring specific professional development experiences in terms of the impact on student learning.

Currently, evaluation of professional development activities, if done at all, consists mainly of assessing participants' reactions to workshops on criteria such as topic relevance, the leader's presentation skills, the quality of the materials, and satisfaction with the format and the setting. This information helps improve the delivery of professional development, but does little to measure the effectiveness of professional development programs on classroom practice.

The system 10 and method 50 provide a continuous process of testing, evaluating, and modifying, which must be sustained by ongoing data collection and evaluation.

Several waves of evaluative research are described before, each designed to provide feedback to teachers and administrators to support ongoing decision-making about strategies for continuous improvement in professional development for teachers.

Phase I: Pre-Registration

At the point in time that teachers register for specific professional development offerings, data will be collected to address objectives related to the teacher's motivation for choosing a particular workshop, class, activity, etc.

Sample Issues or Survey Questions:

How does the choice relate to the individual teacher's development plan?

How does the choice relate to the school's or district's objectives?

What are the teacher's expectations with respect to the impact the professional development activity will have on his/her classroom practice?

What is the presumed/intended relationship between this activity and student needs?

Methodology:

The manage system 10 may administer an online survey to each teacher at the time of registration addressing the objectives stated above. The survey will be triggered by the registration process, and can be designed so that completion of the survey is required before registration can be confirmed.

The survey may me, for example, 7-10 questions long, with a mix of closed-end and open-end questions. It should take approximately 3-4 minutes to complete.

The data from the Pre-Registration Survey will be quantitative in nature and can be reported both in aggregate and by key teacher subgroups, such as subject area taught, length of tenure, etc. A report may be produced that (1) highlights any statistically significant differences between groups of teachers, (2) emphasizes the implications of the research findings and (3) provides recommendations for modification and improvement of this aspect of the professional development process.

Phase II: Post-Class Evaluation

After completion of professional development activities, data will be collected that not only rates the content of the course, but also addresses objectives related to how well the course met the teacher's initial expectations and the applicability of the course to classroom practice.

Sample Issues or Survey Questions:

How well did the course match the teacher's initial expectations? Why or why not?

Did the course provide new understanding into content and instruction?

Did the course provide direction as to how to implement new skills in the classroom?

Did the course encourage strategies for assessing impact of the learning on the classroom?

Did the course encourage both the individual and collaborative talents of teachers?

Methodology:

An online survey to each teacher will be administered in conjunction with the management information system at the time of completion of the course addressing the objectives stated above. Completion of the survey can be required in order to receive credit for the course.

The survey will be 7-10 questions long, with a mix of closed-end and open-end questions. It should take 5-6 minutes to complete.

The data from the Post-Class Survey will be quantitative in nature and can be reported both in aggregate and by key teacher subgroups, such as subject area taught, length of tenure, etc. A report may be produced that (1) highlights any statistically significant differences between groups of teachers, (2) emphasizes the implications of the research findings and (3) provides recommendations for modification and improvement to this aspect of the professional development process and activities.

Phase III: 30/60/90-Day Post-Class Evaluation

To provide further data about applicability and impact of professional development activities on classroom practice, data will be collected at key points in time after class completion. Depending upon the topic and class frequency, surveys at 30, 60 and/or 90 days may be appropriate.

Sample Issues or Survey Questions:

Has the course been applicable in classroom practice? Why or why not?

How has the teacher applied the learning?

Has there been any notable student impact? If so, what type?

Methodology:

The 30/60/90-day Post-Class Surveys may be administered online, with e-mail invitations to the surveys being sent at the appropriate points in time. No additional records will be required to facilitate this process.

The survey will be 7-10 questions long, with a mix of closed-end and open-end questions. It should take 4-5 minutes to complete.

The data from the 30/60/90-Day Post-Class Surveys will be quantitative in nature and can be reported both in aggregate and by key teacher subgroups, such as subject area taught, length of tenure, etc. A report will be produced that (1) highlights any statistically significant differences between groups of teachers, (2) emphasizes the implications of the research findings and (3) provides recommendations for modification and improvement to this aspect of the professional development process and activities.

Returning to FIG. 19, in another aspect of the present invention the system 10 and method 50 forces employees 36 to align their professional development plans with the needs of the students in their classrooms 182, to correlate the data from the system 10, i.e., basic data on each teacher's PD activity and data drawn from quantitative research among users of the system, with the student achievement data 176 to determine which professional development tracks have the most positive impact on student achievement.

For purposes of discussion only, an example of use of the system 10 by a teacher will now be discussed.

After the teacher has logger onto the system 10, the teacher begins by examining screens that list district goals and school improvement plan goals 184. The teacher then inputs his/her personal goals or classroom goals 186 by aligning the teachers needs and the goals of the school improvement plan with the student needs (based on the student performance data).

The teacher, at various times throughout the school year, proceeds to an electronic course catalog within the system 10 and begins the registration process for courses, i.e., classes, workshops, etc.

The system 10 may generate an automatic survey at this point which queries the teacher on a variety of issues relative the choice they are attempting to add to their professional development plan: “Does this choice of PD support your individual goals”? “On a scale of 1-7 where 1 is least likely and 7 is most likely indicate the likelihood of this PD session having a positive impact on your students' needs.”

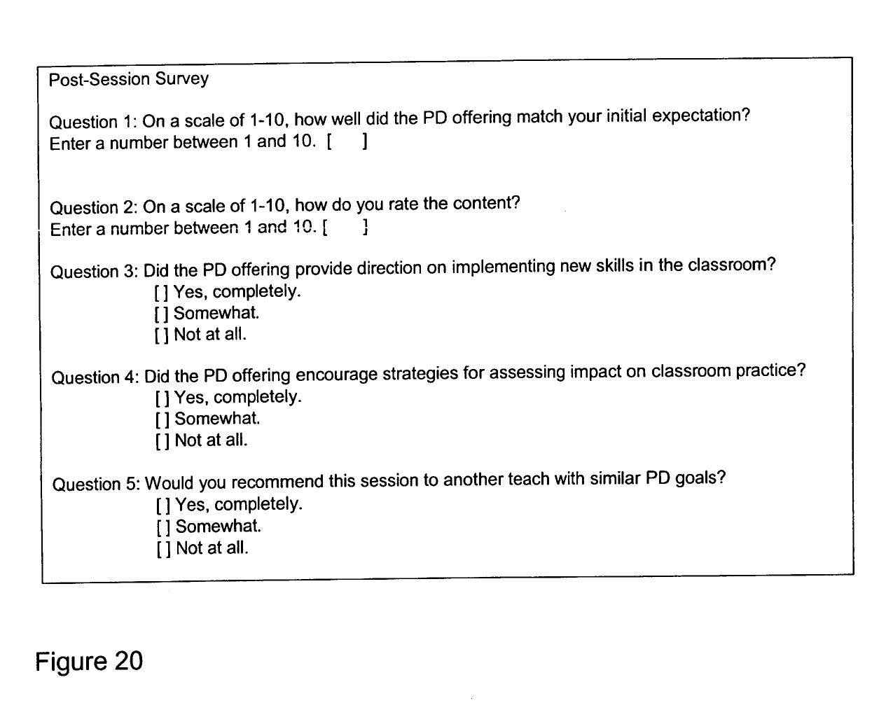

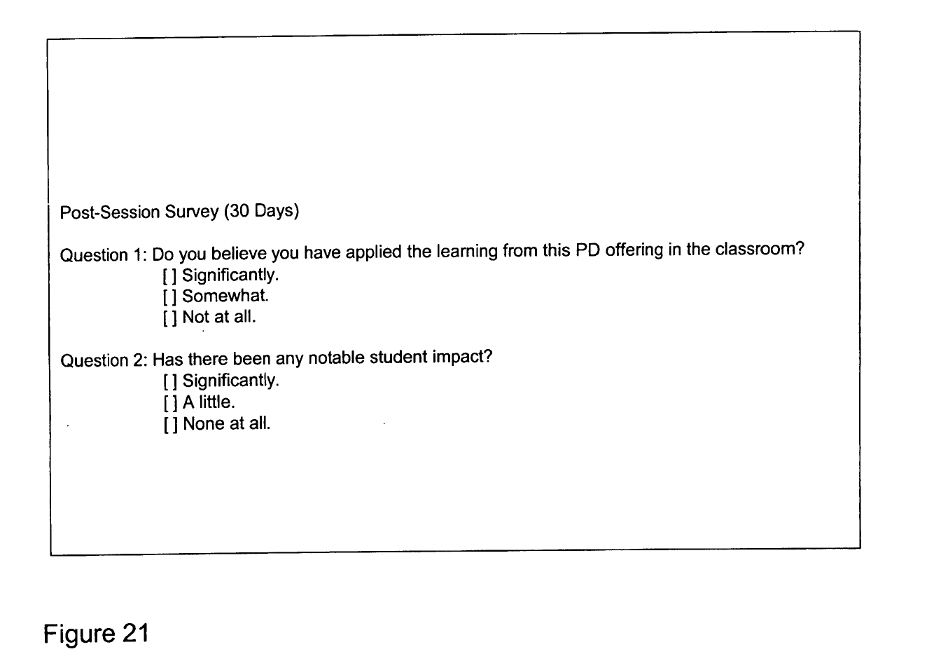

Once the teacher has completed the session another automated survey is sent to the teacher (see above). An exemplary survey is shown in FIG. 20.

An additional survey is sent after the teacher has been back in the classroom for 30 days (see FIG. 20).

Data from the entire district is compiled, compared and analyzed. This data may be used to determine ways to improve on the PD process in consideration of teacher needs and student needs. The data may be used to correlate results with student achievement data to determine which PD plans and individual activities have the greatest positive or negative effect on student achievement.

These findings may also be used to refine the PD process allowing administrators and teachers to use the system as a means of continuous improvement.

The system 10 and method 50 may prepare reports which may be shared with administrators and teachers in qualitative/collaborative sessions to discuss the quantitative findings and explore ways to better impact teacher skills, and thus student learning through enhancement of PD content and context. In addition, teachers will also discuss in depth topical issues and challenges relative their classroom practice and share ideas on approaches that will most immediately impact student achievement.

A report may also be generated which summarizes the key issues addressed in these collaborative sessions and the prescribed initiatives. These findings will be posted on the bulletin board section of the system 10 to encourage further discussion and collaboration among all teachers and administrators.

In one implementation, the system 10 and method 50 will capture, and make available for analysis, data on a variety of levels.

The system 10 may track, at the individual level, all professional development activities for each employee, such as a teacher and provide for the independent review by the teacher's supervisor, professional development committee or the district administrative staff.

The system may track “equivalent” professional development activities for teacher recertification reducing the need for manual tracking and reporting.

The system will track, at the district level, all professional development activities for all teachers. The summary of these professional development activities may be broken down by building, grade-level, content areas and other sub-groups.

The system will record teacher participation in each PD offering.

The system may automatically track professional development alignment with stated state-wide, district-wide, building level or personal professional development goals. This will provide for better integration between PD offerings and the PD choices of the teacher with the needs of the teacher, the students and the building or district as a whole. The alignment will allow the district to track overall PD activity towards specific target goals.

The system may capture quantitative feedback for each professional development activity by each teacher. This will provide real-time feedback to the school district on the teacher-perceived quality of the PD offered by the district and allow for the support of a systematic improvement process and data-driven decision making.

The project may support the capture of qualitative feedback on individual or groups of PD offerings; ways to enhance and refine the survey instruments used to capture quantitative data; and ideas and thoughts on improving the PD tracking process itself.

The system and method 10 may provide for the comparison and analysis of student achievement scores to the professional development activities of the teachers. This will allow the state and the district to spot trends and identify professional development activities that have the greatest overall effect on student achievement. The actual student achievement data used for this comparison will vary from district to district and grade-level to grade-level. It may include student assessment scores, or any other measure of student achievement. The student data will rolled-up by class, content-area or other measures and will be blinded to ensure student privacy. Actual teacher data may also be rolled-up and blinded for privacy. The goal is to compare the effectiveness of PD activities with student achievement, not to capture or compare the performance of individual teachers or students.

Other aspects, object, and features of the present invention may be obtained from a study of the drawings, the disclosure, and the appended claims. Obviously, many modifications and variations of the present invention are possible in light of the above teachings. Furthermore, the invention may be practiced otherwise than as specifically described within the scope of the appended claims.

1. A computer based system for managing and tracking development of employees for an educational organization, the educational organizations having a plurality of students organized into groups, comprising:
a database for storing employee development and requirements data relating to the development of the employees; and,
a first processing unit, coupled to the database, for providing access to the data to the employees and for allowing an employee to manage an employee development plan as a function of the development and requirements data and achievement data related to the progress of the students, for establishing feedback data related to effectiveness of the employee development plan, and for modifying the employee development plan as a function of the effectiveness of the employee development plan.

2. A system, set forth in claim 1, wherein the first processing unit for modifying the requirements data as a function of the effectiveness of the employee development plan.

3. A system, as set forth in claim 1, wherein the employee development plan includes one or more courses related to the employee's development.

4. A system, as set forth in claim 3, the first processing unit be recommending courses for the employee development plan.

5. A system, as set forth in claim 4, where the recommended courses are determined as a function of the employee development and requirements data and the achievement data.

6. A system, as set forth in claim 1, the first processing unit for establishing quantitative data related to the effectiveness of the employee professional development plan.

7. A system, as set forth in claim 6, where the quantitative data is established through evaluative research gathered through one or more online surveys.

8. A system, as set forth in claim 7, the first processing unit for allowing the employee to register for a course through a registration process and for requiring the employee to fill out an online survey prior to registration.

9. A system, as set forth in claim 8, the online survey aimed at objectives related to the employee's motivation for choosing the course for which the employee is registering.

10. A system, as set forth in claim 7, the first processing unit for allowing the employee to register for a course through a registration process and for requiring the employee to fill out an online survey prior after the course has occurred.

11. A system, as set forth in claim 10, the online survey aimed at objectives related to how well the course met the employee's expectations and applicability of the course to practice.

12. A system, as set forth in claim 10, the online survey aimed at determining the applicability and impact of the course on practice at key points in time after completion of the course.

13. A system, as set forth in claim 12, the key points being one or more of 30, 60, or 90 days after completion of the course.

14. A system, as set forth in claim 6, the quantitative data being utilized to modify the employee development plan.

15. A system, as set forth in claim 6, the employee development plan including at least one course to be completed by the employee, the quantitative data being utilized to modify content of the course.

16. A system, as set forth in claim 6, the first processing unit for recommending a course as part of the employee development plan as a function of the quantitative data.

17. A system, as set forth in claim 1, the achievement data being stored in the database.

18. A system, as set forth in claim 1, further comprising a second database for storing the achievement data.

19. A computer based system for managing and tracking development of employees for an educational organization, the educational organizations having a plurality of students organized into groups, comprising:
a database for storing employee development and requirements data relating to the development of the employees; and,
a first processing unit, coupled to the database, for providing access to the data to the employees and for allowing an employee to manage an employee development plan as a function of the development and requirements data and achievement data related to the progress of the students, the employee development plan including one or more courses related to the employee's development, for recommending courses for the employee development plan, for establishing feedback data related to effectiveness of the employee development plan, for establishing quantitative data related to the effectiveness of the employee professional development plan, and for modifying the employee development plan as a function of the quantitative data.

20. A system, set forth in claim 19, wherein the first processing unit for modifying the requirements data as a function of the effectiveness of the employee development plan.

21. A system, as set forth in claim 19, where the quantitative data is established through evaluative research gathered through one or more online surveys.

22. A system, as set forth in claim 21, the first processing unit for allowing the employee to register for a course through a registration process and for requiring the employee to fill out an online survey prior to registration.

23. A system, as set forth in claim 22, the online survey aimed at objectives related to the employee's motivation for choosing the course for which the employee is registering.

24. A system, as set forth in claim 19, the first processing unit for allowing the employee to register for a course through a registration process and for requiring the employee to fill out an online survey prior after the course has occurred.

25. A system, as set forth in claim 24, the online survey aimed at objectives related to how well the course met the employee's expectations and applicability of the course to practice.

26. A system, as set forth in claim 24, the online survey aimed at determining the applicability and impact of the course on practice at key points in time after completion of the course.

27. A system, as set forth in claim 26, the key points being one or more of 30, 60, or 90 days after completion of the course.

28. A system, as set forth in claim 19, the quantitative data being utilized to modify the employee development plan.

29. A system, as set forth in claim 19, the employee development plan including at least one course to be completed by the employee, the quantitative data being utilized to modify content of the course.

30. A system, as set forth in claim 19, the achievement data being stored in the database.

31. A system, as set forth in claim 19, further comprising a second database for storing the achievement data.

32. A computer based method for managing and tracking development of employees for an educational organization, the educational organizations having a plurality of students organized into groups, comprising:
storing employee development and requirements data relating to the development of the employees;
allowing an employee to manage an employee development plan as a function of the development and requirements data and achievement data related to the progress of the students;
establishing feedback data related to effectiveness of the employee development plan; and,
modifying the employee development plan as a function of the effectiveness of the employee development plan.

33. A method, set forth in claim 32, including the step of modifying the requirements data as a function of the effectiveness of the employee development plan.

34. A method, as set forth in claim 32, wherein the employee development plan includes one or more courses related to the employee's development.

35. A method, as set forth in claim 34, the first processing unit be recommending courses for the employee development plan.

36. A method, as set forth in claim 35, where the recommended courses are determined as a function of the employee development and requirements data and the achievement data.

37. A method, as set forth in claim 32, including the step of establishing quantitative data related to the effectiveness of the employee professional development plan.

38. A method, as set forth in claim 37, where the quantitative data is established through evaluative research gathered through one or more online surveys.

39. A method, as set forth in claim 38, including the steps of allowing the employee to register for a course through a registration process and requiring the employee to fill out an online survey prior to registration.

40. A method, as set forth in claim 39, the online survey aimed at objectives related to the employee's motivation for choosing the course for which the employee is registering.

41. A method, as set forth in claim 38, including the steps of allowing the employee to register for a course through a registration process and requiring the employee to fill out an online survey prior after the course has occurred.

42. A method, as set forth in claim 41, the online survey aimed at objectives related to how well the course met the employee's expectations and applicability of the course to practice.

43. A method, as set forth in claim 41, the online survey aimed at determining the applicability and impact of the course on practice at key points in time after completion of the course.

44. A method, as set forth in claim 43, the key points being one or more of 30, 60, or 90 days after completion of the course.

45. A method, as set forth in claim 37, the quantitative data being utilized to modify the employee development plan.

46. A method, as set forth in claim 37, the employee development plan including at least one course to be completed by the employee, the quantitative data being utilized to modify content of the course.

47. A method, as set forth in claim 37, including the step of recommending a course as part of the employee development plan as a function of the quantitative data.

48. A system, as set forth in claim 32, the achievement data being stored in the database.

49. A system, as set forth in claim 32, the achievement data being stored in a second database.

50. A computer based method for managing and tracking development of employees for an educational organization, the educational organizations having a plurality of students organized into groups, including the steps of:
storing employee development and requirements data relating to the development of the employees in a database;
providing access to the data to the employees;
allowing an employee to manage an employee development plan as a function of the development and requirements data and achievement data related to the progress of the students, the employee development plan including one or more courses related to the employee's development;
recommending courses for the employee development plan;
establishing quantitative data related to the effectiveness of the employee professional development plan; and,
modifying the employee development plan as a function of the quantitative data.

51. A method, set forth in claim 50, including the step of modifying the requirements data as a function of the effectiveness of the employee development plan.

52. A method, as set forth in claim 50, where the quantitative data is established through evaluative research gathered through one or more online surveys.

53. A method, as set forth in claim 50, including the steps of allowing the employee to register for a course through a registration process and requiring the employee to fill out an online survey prior to registration.

54. A method, as set forth in claim 53, the online survey aimed at objectives related to the employee's motivation for choosing the course for which the employee is registering.

55. A method, as set forth in claim 50, including the steps of allowing the employee to register for a course through a registration process and requiring the employee to fill out an online survey prior after the course has occurred.

56. A method, as set forth in claim 55, the online survey aimed at objectives related to how well the course met the employee's expectations and applicability of the course to practice.

57. A method, as set forth in claim 55, the online survey aimed at determining the applicability and impact of the course on practice at key points in time after completion of the course.

58. A method, as set forth in claim 57, the key points being one or more of 30, 60, or 90 days after completion of the course.

59. A method, as set forth in claim 50, the quantitative data being utilized to modify the employee development plan.

60. A method, as set forth in claim 50, the employee development plan including at least one course to be completed by the employee, the quantitative data being utilized to modify content of the course.

61. A method, as set forth in claim 50, the achievement data being stored in the database.

62. A method, as set forth in claim 50, the achievement data being stored in a second database.
